(19) United States
(12) Patent Application Publication
(10) Pub. No.: US 2003/0018673 A1
(43) Pub. Date: Jan. 23, 2003

(54) Physical units in a signal processing system

(76) Inventors: Karl-Heinz Maier, Nuremberg (DE); Nicolai Plewinski, Rothenbach/Peg. (DE)

Correspondence Address: Siemens Corporation, Intellectual Property Department, 186 Wood Avenue South, Iselin, NJ, 08830, US

(21) Appl. No.: 09/861,074

(22) Filed: May 18, 2001

(51) Int. Cl. G06F 7/00

(52) U.S. Cl. 708/206

(57) ABSTRACT

A method and processing system are disclosed in which a signal acquisition unit is provided for receiving a signal corresponding to a scalar value of a magnitude, and at least one referencing unit is used for correlating a unit object of the magnitude with the scalar value. A processor is provided for processing the magnitude such that a transformation of the scalar value is accompanied by a corresponding transformation of the unit object.

### BACKGROUND OF THE INVENTION

The present invention is directed to the field of data processing systems, particularly those of the type that perform calculations involving physical quantities. Physical magnitudes are represented by a scalar (i.e., numerical value) and a unit that characterizes the physical quantity measured by the scalar. Data processing systems only perform computations with the scalar value, and no unit arithmetic is performed. The semantics of the unit operations are not taken into account by the processing system.

When a computed physical magnitude is displayed, the system can only display the scalar value. The user must specify the unit. Thus, the user must consider the nature and manner of the calculation in order to specify the correct composite. This can create additional problems if units are inadvertently confused, such as by degrees of factors (e.g., “mm” (10⁻³ m) and “cm” (10⁻² m)), exponent values (e.g., “area” vs. “volume”) and transformation between systems of measurement (SI units vs. US standard units).

In previous systems it has been known that units for a physical magnitude can be assigned an arbitrary character string, which is used to display the final result of a calculation. However, this character string is not processed by the system, and the data processing system does not comprehend the operational semantics of the unit conversion in mathematical operations. Thus, the system is unable to specify the units of the results in order to resolve the problems mentioned above.

### SUMMARY OF THE INVENTION

In view of the difficulties and drawbacks encountered with previous-type methods and systems, there is therefore a need for a method and processing system that considers the semantics of unit operations.

There is also a need for a method and processing system that allows cross-referencing between standards of units.

There is also a need for a method and processing system that reduces inadvertent confusion between units.

These needs and others are satisfied by the method and processing system of the present invention in which a signal acquisition unit is provided for receiving a signal corresponding to a scalar value of a magnitude, and at least one referencing unit is used for correlating a unit object of the magnitude with the scalar value. A processor is provided for processing the magnitude such that a transformation of the scalar value is accompanied by a corresponding transformation of the unit object.

As will be realized, the invention is capable of other and different embodiments and its several details are capable of modifications in various respects, all without departing from the invention. Accordingly, the drawing and description are to be regarded as illustrative and not restrictive.

### BRIEF DESCRIPTION OF THE DRAWINGS

FIG. 1 depicts a processing system according to a first embodiment of the present invention.

FIG. 2 depicts a processing system according to a second embodiment of the present invention.

FIG. 3 depicts the internal representation of the present unit object.

### DETAILED DESCRIPTION OF THE INVENTION

With the present invention, a physical magnitude is represented by a scalar value and an associated unit object. The magnitude is processed in such a way that a transformation of the scalar value is accompanied by a corresponding transformation of the unit object. In the present invention an arithmetic operation is performed between a first magnitude and a second magnitude, where each magnitude has a respective scalar value and a respective unit object. In performing an arithmetic operation, e.g., a multiplication operation, the resulting product is represented by the product of the respective first and second scalar values and a product of the respective first and second unit objects.

A physical unit object is expressed by one or more base units, preferably in SI units, where “SI units” are “Systeme Internationale d'Unites” or the “International System of Units.” However, the base units can also be expressed by other unit standards, such as American Standard units or any other unit standard that might be contemplated. Also, the present invention allows instant conversion between systems of standard units, as will be made clear below.

As shown in FIG. 3, a unit object 10 is represented within the present system as a “triplet”. The unit object 10 is composed of a base unit 12, an exponent value 14 and a power 16 which are multiplicatively associated. For example, the following units are expressed as follows:

kilometer=km=(10³*m)¹

square millimeter=mm²=(10⁻³*m)²

cubic centimeter=cm³=(10⁻²*m)³

In all the above examples, “m” represents “meters”, the standard SI unit of length, as the base unit 12. The values “10³,” “10⁻³”, and “10⁻²” represent the exponent value 14 where the respective units “kilometer”, “millimeter” and “centimeter” are represented as respective multiples or fractions of the base unit 12. The power 16 is shown as a respective power of the base unit 12 and the exponent value 14 contained in the parentheses, which refers to the “dimension” of the unit object 10. The structure of the unit triplet is represented in C syntax as follows:

struct UNIT
{

long 1SI unit ID;
long 1UnitExponent;
double 1fUnitPower;

};

The management of this structure is performed by a (COM) object that also does the unit arithmetic. For example, the calculation of an area is expressed as:

[(10⁰*m¹]*[(10⁰*m¹]

The two unit objects are linked by multiplication so as to yield a unit object 10 in which the powers are added: ([(10⁰*m²]). The unit object 10 can also be formatted as a character string so that it can be displayed to the user. For example, an acceleration product represented internally as [(10³*m¹[(10⁰*s⁻²] is outputted as “km*sˆ (−2)”

In another example, a “kurtosis” is a measure of the conservation of momentum, and is calculated from a plurality of acceleration values, kurtosis is defined as follows:

$${m}_{kurtosis} = 1 / ( n - 1 ) {\sum }_{i = 1}^{n} {( {x}^{i} - x )}^{4}$$

where n=number of values

As is apparent, if the values are squared, so is the unit. In addition, the individual powers of the unit triplet are multiplied by 4, so that the unit of the input values ([(10⁰*m)¹]*[(10⁰*s)⁻²]) becomes the unit of the kurtosis:

$$( [ {( {10}^{o} * m )}^{1 * 4} ] * [ {( {10}^{o} * m )}^{- 2 * 4} ] ) = ( [ {( {10}^{o} * m )}^{4} ] * [ {( {10}^{o} * s )}^{- 8} ] ) .$$

In another example, consider the period of a harmonic oscillation:

T==2π[m/(−F/s)]^{1/2}

The unit object is expressed as:

{[(10³*g)¹]*[(10⁰*m)¹]*([(10³*g)⁻¹]*[(10⁰*m)⁻¹]*[(10⁰*s)²])}^{0.5}

The grams and meters as units are canceled out by their powers, and there remains:

$${\{ [ {( {10}^{o} * s )}^{2} ] \}}^{0.5} = [ {( {10}^{o} * s )}^{2 * 0.5} ] = [ {( {10}^{o} * s )}^{1} ]$$

As expected, the unit object that results is the “second”. With the present invention, physical magnitudes can be processed through numerous steps, and the resulting unit object 10 remains consistent, since each processing step “knows” how the unit is affected.

The present algorithm can also perform conversion between disparate unit objects and output a desired unit object. For example, a product between “kilometers” and “meters” is represented internally as [(10³*m)¹]*[(10⁰*m)¹] and can be outputted as m² or km², or any other desired output (e.g. cm² or mm²). The present algorithm can also be adapted to allow addition and substraction of units of disparate exponent value 14 that represent similar physical magnitudes of the same power 16, as long as such units are properly specified by the user. For example, “kilometers” (10³*m)¹ can be added to “meters” (10^{0*}m)¹ and the output can be optionally expressed by either unit object 10. In a further alternative realization of the invention, the present algorithm can also be adapted to perform arithmetic operations between physical magnitudes in disparate systems of standard units, by applying an appropriate conversion factor. For example, “kilometers” and “miles” could be added, and the result can be optionally be outputted as either unit object 10.

The present invention can be realized in any number of embodiments, where the scalar value can be inputted as a signal acquired from any number of sources. Also, the present algorithm can be implemented as software, firmware or a hardwired circuit, or any combination thereof, in order to satisfy any particular requirement of a desired implementation. In the preferred embodiment, the scalar value is the result of a measurement signal generated by a sensor.

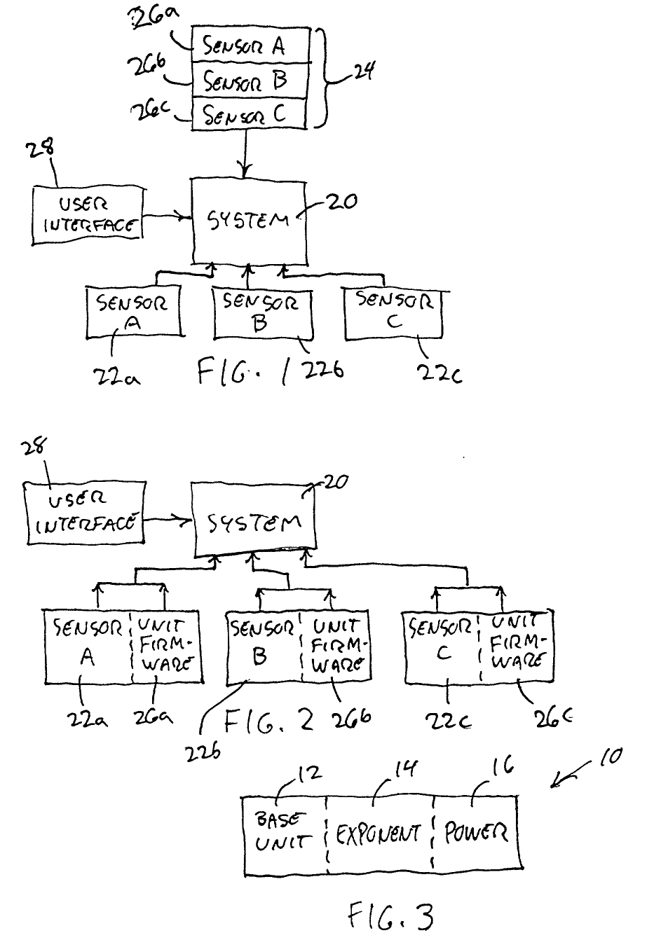

As shown in the first embodiment of FIG. 1, a system 20 is provided that includes a processor, memory and other standard components such as are known in the art for executing a desired algorithm. A plurality of sensors 22a, 22b, 22c are provided that generate measurement signals corresponding to scalar values of the measured physical magnitudes. The system 20 includes a signal acquisition unit for receiving the signals. The signal acquisition unit can be a connection to a bus or network, and/or a modem for connecting to an internet, or a wireless receiver for receiving sensor data through the air, or any other such means as will be known in the art.

In the present invention, a referencing unit is provided for correlating the unit object 10 of the physical magnitude with the scalar value. As shown in FIG. 1, the unit objects 10 for each sensor are supplied to the system 20 by a catalog 24 that retains respective unit object values 26a, 26b, 26c that respectively correspond to the sensors 22a, 22b, 22c. The catalog 24 can retain the unit object values 26a, 26b, 26 as data in volatile memory, or else these values can be hard-written into a ROM or circuit realization. In the embodiment of FIG. 1, the user selects the sensors to be used from a catalog and the system 20 reads the unit object 10 from the data stored in the catalog 24, for further processing. The system 20 processes the physical magnitude so that a transformation of the scalar value is accompanies by a corresponding transformation of the unit object 10. That is, any arithmetic operation between measured and/or referenced scalar values will be accompanied by a corresponding arithmetic operation between unit objects, as explicated above.

FIG. 2 shows a second embodiment of the invention, where like reference numerals refer to like elements. In this embodiment, each sensor 22a, 22b, 22c includes sensor firmware that retains the unit object value data 26a, 26b, 26c that corresponds to each sensor. In this way, the unit object data can be read directly, in order to allow “plug and play” operation of the sensors, without requiring a discrete catalog 24 as with the embodiment of FIG. 1. In either embodiment, a user interface 28 can be provided in order to enable the user to specify a desired unit, and the system will then convert the entry into the internal format. In the present invention, the units are thus not treated as an arbitrary character string by the data processing system. In the present method, the semantics of the units are preserved by the way in which the data are stored. The data processing system can therefore independently determine the unit object to accompany the resulting scalar value.

As described hereinabove, the present invention solves many problems associated with previous type systems. However, it will be appreciated that various changes in the details, materials and arrangements of parts which may have been herein described and illustrated in order to explain the nature of the invention may be made by those skilled in the art within the principle and scope of the invention will be expressed in the appended claims.

We claim:

1. A processing method comprising:
providing a magnitude composed of a scalar value and a unit object; and
processing the magnitude such that a transformation of the scalar value is accompanied by a corresponding transformation of the unit object.

2. The processing method of claim 1 wherein the step of providing further comprises measuring the scalar value from a sensor.

3. The processing method of claim 1 wherein the step of providing further comprises referencing the unit object from a catalog of unit objects.

4. The processing method of claim 1 wherein the step of providing further comprises manually specifying the unit object.

5. The processing method of claim 1 wherein the magnitude is a first magnitude composed of a first scalar value and a first unit object and wherein the step of processing comprises a step of performing an arithmetic operation between the first magnitude and a second magnitude composed of a second scalar value and a second unit object.

6. The processing method of claim 5 wherein the step of performing an arithmetic operation comprises performing a multiplication operation such that a resulting product is composed of a product or the first and second scalar values and a product of the first and second unit objects.

7. The processing method of claim 6 wherein the unit object is composed of a base unit, an exponent and a power.

8. A computer usable medium having computer readable program code embodied therein for processing, the computer readable program code into a computer program product comprising:
instructions for providing a magnitude composed of a scalar value and a unit object; and
instructions for processing the magnitude such that a transformation of the scalar value is accompanied by a corresponding transformation of the unit object.

9. The computer program product of claim 8 wherein the instructions for providing further comprises instructions for measuring the scalar value from a sensor.

10. The computer program product of claim 8 wherein the instructions for providing further comprises instructions for referencing the unit object from a catalog of unit objects.

11. The computer program product of claim 8 wherein the instructions for providing further comprises instructions for manually specifying the unit object.

12. The computer program product of claim 8 wherein the magnitude is a first magnitude composed of a first scalar value and a first unit object and wherein the instructions for processing comprise instructions for performing an arithmetic operation between the first magnitude and a second magnitude composed of a second scalar value and a second unit object.

13. The computer program product of claim 12 wherein the instructions for performing an arithmetic operation comprise instructions for performing a multiplication operation such that a resulting product is composed of a product or the first and second scalar values and a product of the first and second unit objects.

14. The computer program product of claim 13 wherein the unit object is composed of a base unit, an exponent and a power.

15. A processing system comprising:
a signal acquisition unit for receiving a signal corresponding to a scalar value of a magnitude;
at least one referencing unit for correlating a unit object of the magnitude with the scalar value; and
a processor for processing the magnitude such that a transformation of the scalar value is accompanied by a corresponding transformation of the unit object.

16. The processing system of claim 15 further comprising a sensor for generating the signal corresponding to the scalar value.

17. The processing system of claim 16 wherein the sensor comprises the referencing unit for supplying the unit object with the scalar value to the processing system.

18. The processing system of claim 15 wherein the referencing unit comprises a catalog of unit objects.

19. The processing system of claim 15 further comprising a user interface for manually specifying the unit object.

20. The processing system of claim 15 wherein the magnitude is a first magnitude composed of a first scalar value and a first unit object, and further comprising means for performing an arithmetic operation between the first magnitude and a second magnitude composed of a second scalar value and a second unit object.

21. The processing system of claim 20 wherein the means for performing an arithmetic operation comprises means for performing a multiplication operation such that a resulting product is composed of a product of first and second scalar values and a product of first and second unit objects.

22. The processing system of claim 21 wherein the unit object is composed of a base unit, an exponent and a power.
